(19) United States
(12) Patent Application Publication
(10) Pub. No.: US 2010/0203199 A1
(43) Pub. Date: Aug. 12, 2010

(54) Packaged Salad

(76) Inventor: Jay Ferro, Santa Barbara, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/761,296

(22) Filed: Apr. 15, 2010

Related U.S. Application Data
(63) Continuation-in-part of application No. 11/308,293, filed on Mar. 15, 2006, now abandoned.
(60) Provisional application No. 60/594,204, filed on Mar. 18, 2005.

(51) Int. Cl. B65D 85/16; A23L 1/212; A23L 1/24

(52) U.S. Cl. 426/111; 426/394; 426/589

(57) ABSTRACT

There is disclosed a packaged salad. The packaged salad includes an undressed salad comprising a plurality of solid food items, and a package containing the salad. The package has a smaller distribution mode and a larger, expanded consumption mode. One or more air vents allow air to enter the package to prevent negative air pressure from impeding a user from expanding the package from distribution mode to consumption mode. Processes for using the package are also disclosed.

### RELATED APPLICATION INFORMATION

This patent is a continuation-in-part of U.S. application Ser. No. 11/308,293 filed Mar. 15, 2006, which is incorporated herein by reference and abandoned after the filing date of this patent. application Ser. No. 11/308,293 claims the benefit of Provisional Application No. 60/594,204, filed Mar. 18, 2005.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to packaged salads.

2. Description of the Related Art

Salads from food service establishments (primarily quick-service restaurants) are typically sold in plastic containers (many times they look like salad bowls) with a lid. Often times the salad and its toppings are packed to the top of the container in order to use all available container space, with the lid possibly stabilizing the entire salad contents.

However, there are problems with this existing arrangement: First, since it is difficult and time consuming to achieve a uniform dispersion of salad dressing on the entire salad within that same container, when a customer pours on the salad dressing, they have no choice but to put it on only the top of the salad, thereby getting too much on some parts and not enough on others. Second, often times customers use more salad dressing than they need because of this problem. Third, when the customer does attempt to toss the salad, they must either empty the contents into a larger bowl and use utensils to toss, or attempt tossing it in the existing container, thereby losing product and creating a mess. Fourth, when the salad is not tossed, customers often time eat the salad toppings because that is what is most accessible and leave the lettuce at the bottom of the bowl. This can significantly defeat the intended texture and experience of the salad, especially when the salads were intended to be tossed (for example, a Caesar salad and the like).

Customers often justify paying two to three times the amount of money for a similar tossed salad, primarily due to the ease of consuming and an intended experience of consuming the pre-tossed salad is greater. Many quick service restaurants often therefore price similar but un-tossed salads lower than the pre-tossed counterparts, because of the real or imagined compromise in their product and not giving the customer the anticipated perceived salad consuming experience and value. Further, when a salad is tossed, different people desire different amounts of salad dressing, dictated by many factors including taste, diet, and the like.

### DESCRIPTION OF THE DRAWINGS

FIG. 1 is a side view of a first packaged salad in distribution mode.

FIG. 2 is a side view of the first packaged salad in consumption mode.

FIG. 3 is a top view of a lid of the packaged salad.

FIG. 4 is a side view of a second packaged salad in distribution mode.

FIG. 5 is a side view of the second packaged salad in consumption mode.

FIG. 6 is a flowchart of a process for enjoying a packaged salad.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

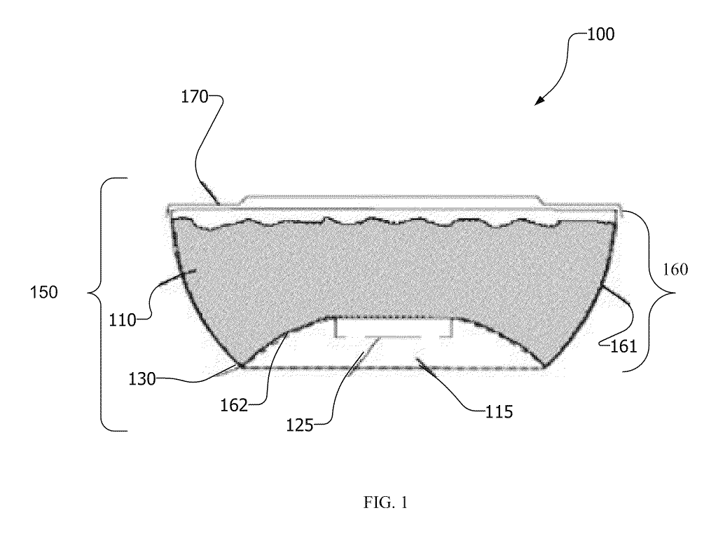

Referring now to FIG. 1 there is shown a side view of a first packaged salad 100 in a distribution mode. The packaged salad 100 is a salad 110 disposed in a package 150.

The salad 110 is a combination of solid food items and its paradigm is the green salad. The solid food items in the salad 110 must include one or more pieces of a vegetable leaf, a non-leaf vegetable, a pasta, a noodle, a legume, a grain, a nut, a crouton, a cheese, an egg, a meat, a poultry, a seafood, or a fruit. The salad 110 may contain various items which are cold, warm or hot. The solid food items may be raw or cooked, dried or moist.

Substantially all of the solid food items in the salad 110 are larger than a critical size. The critical size is larger than a typical spice grain or piece of herb. More precisely, the critical size is 5 mm³ or less, and better below 2 mm³.

The salad 110 lacks a dressing (not shown). The dressing is a sauce for the salad 110. The dressing is either a liquid or suspension, or a mixture whose primary ingredients are either a liquid or a suspension. The dressing may be as thin as water but not as thick as a paste. The dressing may be, for example: blue cheese dressing, Caesar dressing, extra virgin olive oil, French dressing, honey Dijon, Italian dressing, Louis dressing, ranch dressing, rice vinegar, Russian dressing, tahini, Thousand Island dressing, or vinaigrette. Hummus is typically a paste, though it may be thin or made thin enough to be a dressing.

A binder is a sauce which holds together solid food items. A binder may be used as the dressing, though a thick binder is generally inappropriate as a dressing. The salad 110 may include bound ingredients such as tuna salad whose pieces are smaller than the critical size but which aggregate from the binder to a size larger than the critical size and are therefore effectively larger than the critical size. Mayonnaise is a binders. A thick binder is usually inappropriate as a dressing, but a thin binder can work quite well as a dressing.

The salad 110 may be or include, for example: bean salad, Caesar salad, Chef salad, Chicken salad, Chinese chicken salad, cobb salad, cole slaw, crab Louie, fattoush, fruit salad, gado-gado, garden salad, Greek salad, Israeli salad, larb, mesclun, Nicoise salad, Shirazi salad, tabbouleh, or taco salad. The salad 100 may include bound items such as tuna salad, egg salad, ham salad, macaroni salad, pasta salad, or potato salad, though the salad 110 may instead be the “dry” ingredients without the binder.

The package 150 has an inside and an outside, a top and a bottom. The interior of the package 150 defines a volume between 16 fluid oz and 64 fluid oz when in the distribution mode, with a 36 fluid oz size well suited for a single-serving. The salad 110 occupies between 75% and 99% of the that volume. Though the salad 110 could occupy considerably less than the full volume of the package 150, efficiency urges otherwise. In this way, the package 150 is only so big as needed, and salad 110 occupies substantially the full available space within the package 150.

The package 150 includes a container 160 having a sidewall portion 161 and a bottom portion 162 together providing a generally bowl-shaped and substantially leak-proof structure. On top of the container 160 is a lid 170. The lid 170 is removably mated to the top of the sidewall portion 161 of the container 160. The lid 170 and the container 160 have a seals which prevent leaks of the salad 110 and dressing during tossing. The lid 170 may be permanently or semi-permanently attached to the container 160 in a manner that allows the lid 170 to be opened (i.e., removed) from the container 150 and closed back onto the container.

The bottom portion 162 is at the bottom of the container 160. In the distribution mode, the bottom portion 162 is in an upper position inside the sidewall 161 and defines a cavity. The cavity is configured so that when the bottom portion 162 is in the distribution mode, the cavity has an interface with the sidewall portion 161 which provides a stable base for the packaged salad 100.

The container 160 includes a tab 125 attached to the outside of the bottom portion 162. A person can pull on the tab 125 to move the bottom portion 162 from the upper position (distribution mode) to a lower position (consumption mode).

The transition from distribution mode to consumption mode may be one-way. That is, once the package 150 is in consumption mode, it cannot be returned to the shape it had when in distribution mode.

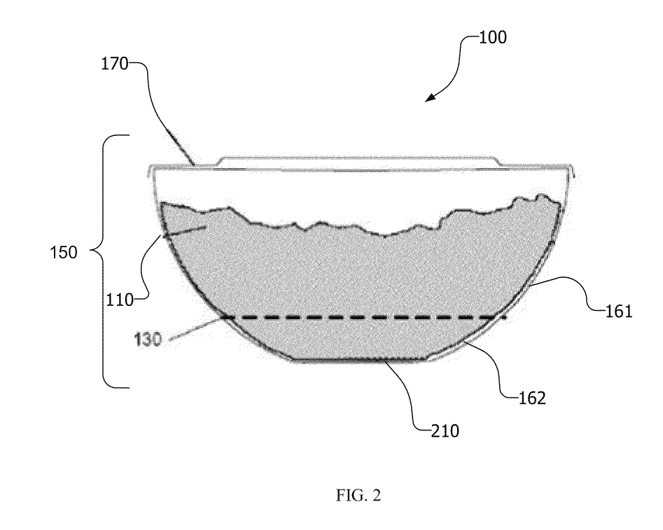

Referring now to FIG. 2 there is shown a side view of the packaged salad 100 in consumption mode. In the consumption mode, the bottom portion 162 is in a lower position below the sidewall 161. By moving the cavity down, the package 150 has a greater volume than when the cavity is in the upper position. This greater volume provides space for the salad 110 and a salad dressing to be evenly tossed by shaking the package 150. The consumption mode volume may between 120% and 200% of the distribution mode volume. For a package in distribution mode of 36 fluid oz, consumption mode of 48 fluid oz is well suited.

The cavity has a flattened section 210 which provides a stable base for the packaged salad 100.

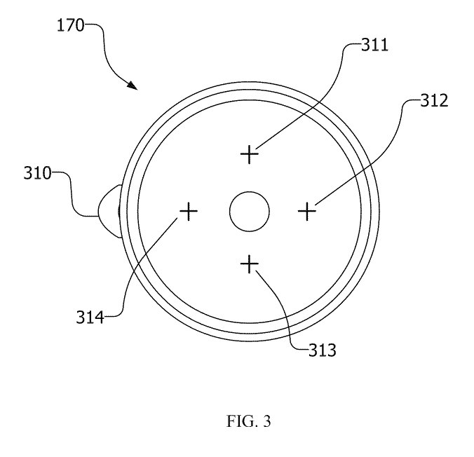

Referring now to FIG. 3 there is shown a top view of the lid 170. The lid 170 has an air vent arrangement comprising four air vents 311, 312, 313, 314. The air vent arrangement allows air to enter the package 150 when the package 150 is transitioned from distribution mode to consumption mode. The number and shape of the air vents are selected to allow enough air to enter the package 150 to prevent negative air pressure from impeding a user from expanding the sealed package from distribution mode to consumption mode. This generally favors larger and more numerous vents. The number and shape of the vents are also selected to prevent the salad 110, its constituents and the dressing from escaping (e.g., leaking) through the vents when the package 150 is shaken to toss the salad 110. This generally favors smaller and least numerous vents. The vents may be slits such as shown in FIG. 3. However, larger vents are adequate because when the salad is tossed its constituents may block the vents and therefore prevent the dressing from leaking.

The lid 170 may also include a lip 310 which provides a convenient place to grip and lift the lid 170 or close the lid 170.

After the salad 110 is packaged it may settle due to gravity with or without shaking.

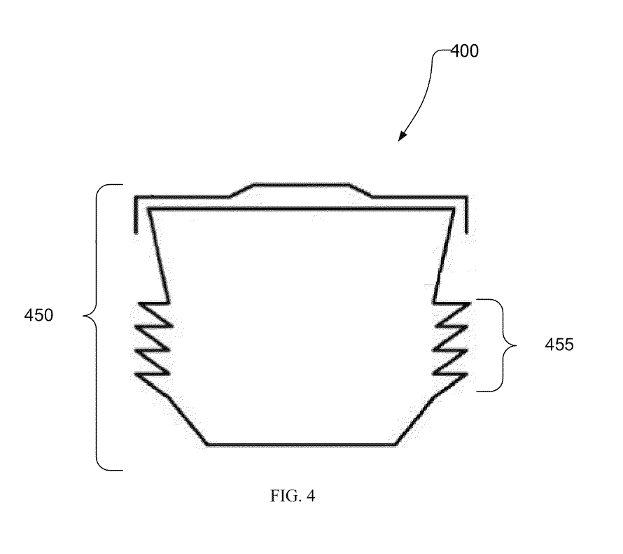

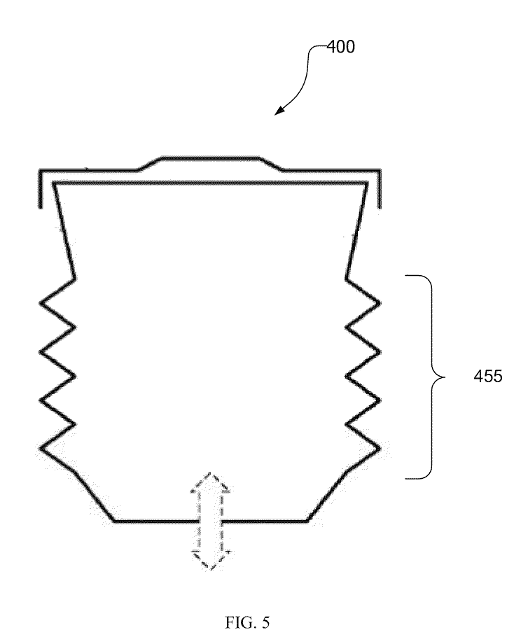

FIG. 4 is a side view of another packaged salad 400, in distribution mode. FIG. 5 shows the packaged salad 400 in consumption mode. Instead of the cavity and tab arrangement of FIG. 1, the packaged salad 400 of FIG. 4 has an accordion-pleated portion 455. The user can transition the package 450 between distribution mode and consumption mode by expanding the accordion-pleated portion 455, i.e., by gripping the package 450 above and below the portion 455 and pulling.

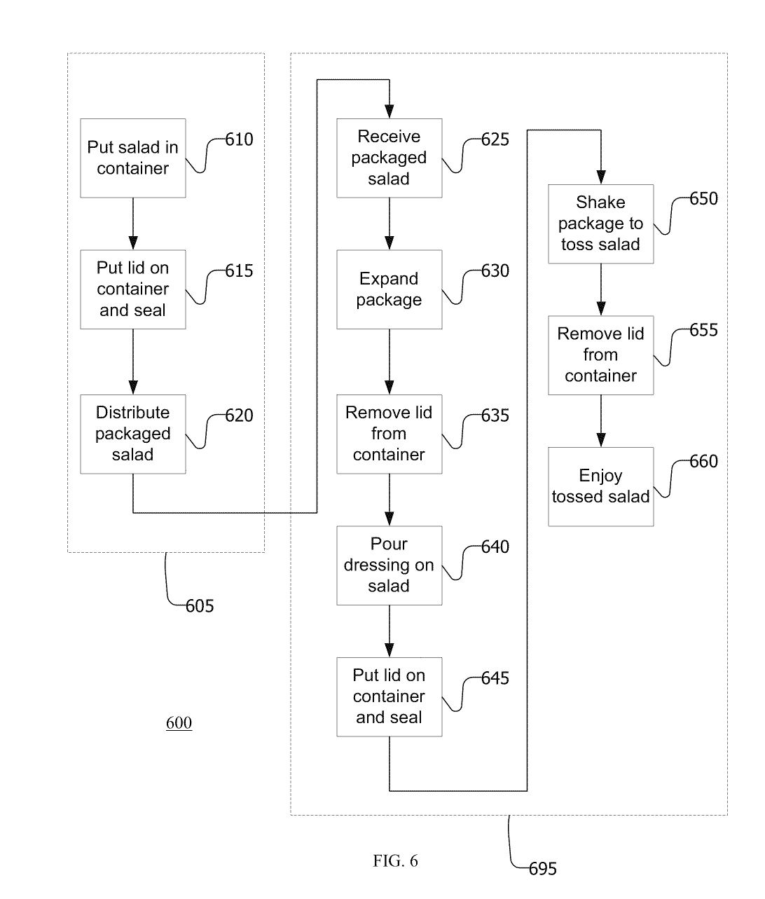

Referring now to FIG. 6 there is shown a flowchart of a process 600 for enjoying a packaged salad. The process includes a distribution portion 605 and a consumption portion 695.

The distribution portion 605 includes steps 610 through 620. In step 610, a salad such as the salad 110 is placed into a container such as the container 160. In addition to the salad other items may be placed into the package such as a package of salad dressing, eating utensils such as a fork or chopsticks, and/or a package of croutons. In step 615, a lid such as the lid 170 is placed onto the container and sealed to render the salad packaged. In step 620 the packaged salad is distributed. The distribution 605 may be performed by a vendor such as a restaurant, by an end user, or by someone acting on behalf of the end user. All or selected steps of the distribution 605 may be performed manually or mechanically.

The consumption portion 695 includes steps 625 through 660. In step 625 the packaged salad is received by someone such as the end user. In step 630 the package is expanded as described above. In step 635 the lid is removed from the container. If a dressing package, crouton package, utensils, or other item is in the package, these may be removed. In step 645 the dressing and/or other items are added to the salad in the container. In step 645 the lid is replaced and resealed on the container. In step 650 the package is shaken to toss the salad. In step 655 the lid is removed from the container. In step 660 the end user enjoys the tossed salad.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A packaged salad comprising:
an undressed salad comprising a plurality of solid food items including one or more pieces of a vegetable leaf, a non-leaf vegetable, a pasta, a noodle, a legume, a grain, a nut, a cheese, an egg, a meat, a poultry, a seafood, a fruit;
a package containing the salad, the package having an inside and an outside, a top and a bottom, the package defining a first volume of between 16 fluid oz and 64 fluid oz when in a distribution mode and a second volume of between 120% and 200% of the first volume when expanded to a consumption mode, the package comprising:
a container having a generally bowl-like shape and providing a substantially leak-proof structure,
a lid removably mated and sealed to the container;
an air vent arrangement comprising at least one air vent, the air vent arrangement system sufficient to allow air to enter the package to prevent negative air pressure from impeding a user from expanding the package from distribution mode to consumption mode.

2. The packaged salad of claim 1 wherein the salad consists of a mixture of items which are all larger than a critical size.

3. The packaged salad of claim 1 wherein the salad occupies between 75% and 99% of the first volume.

4. The packaged salad of claim 1 wherein the package cannot be returned from consumption mode to distribution mode.

5. The packaged salad of claim 1 wherein the lid and container seal sufficiently to prevent leaks of a dressing during tossing.

6. The packaged salad of claim 1 wherein the one or more air vents are adapted to prevent a dressing added to the salad from leaking through the air vents.

7. The packaged salad of claim 1 wherein the package has a volume of 36 fluid oz in distribution mode and a volume of 48 fluid oz in consumption mode.

8. A process for packaging a salad comprising:
placing an undressed salad into a package, wherein
the undressed salad comprises a plurality of solid food items including one or more pieces of a vegetable leaf, a non-leaf vegetable, a pasta, a noodle, a legume, a grain, a nut, a cheese, an egg, a meat, a poultry, a seafood, a fruit;
the package has an inside and an outside, a top and a bottom, the package defining a first volume of between 16 fluid oz and 64 fluid oz when in a distribution mode and a second volume of between 120% and 200% of the first volume when expanded to a consumption mode, the package comprising:
a container having a generally bowl-like shape and providing a substantially leak-proof structure,
a lid removably mated and sealed to the container;
an air vent arrangement comprising at least one air vent, the air vent arrangement system sufficient to allow air to enter the package to prevent negative air pressure from impeding a user from expanding the package from distribution mode to consumption mode;
placing the lid onto the container;
sealing the lid to the container.

9. The process of claim 8, further comprising, before placing the lid onto the container, placing at least one of a package of salad dressing, an eating utensil and a package of croutons into the package.

10. A process for tossing a packaged salad comprising
expanding a package to a consumption mode, the package containing an undressed salad, wherein
the undressed salad comprises a plurality of solid food items including one or more pieces of a vegetable leaf, a non-leaf vegetable, a pasta, a noodle, a legume, a grain, a nut, a cheese, an egg, a meat, a poultry, a seafood, a fruit;
the package has an inside and an outside, a top and a bottom, the package defining a first volume of between 16 fluid oz and 64 fluid oz when in a distribution mode and a second volume of between 120% and 200% of the first volume when expanded to a consumption mode, the package comprising:
a container having a generally bowl-like shape and providing a substantially leak-proof structure,
a lid removably mated and sealed to the container;
an air vent arrangement comprising at least one air vent, the air vent arrangement system sufficient to allow air to enter the package to prevent negative air pressure from impeding a user from expanding the package from distribution mode to consumption mode;
moving the lid away from the container;
putting a dressing into the opened package;
replacing and resealing the lid on the container;
shaking the package until the salad is tossed with the dressing.

11. The process of claim 10 further comprising
removing the lid from the container
eating the tossed salad.
